(19) United States
(12) Patent Application Publication
(10) Pub. No.: US 2007/0262923 A1
(43) Pub. Date: Nov. 15, 2007

(54) Method of testing lighting of plasma display panel

(76) Inventors: Kotaro Kobayashi, Osaka (JP); Teiichi Kimura, Osaka (JP); Jun Yokoyama, Osaka (JP)

Correspondence Address: MCDERMOTT WILL & EMERY LLP, 600 13TH STREET, NW, WASHINGTON, DC, 20005-3096, US

(21) Appl. No.: 11/797,949

(22) Filed: May 9, 2007

(30) Foreign Application Priority Data
May 12, 2006 (JP) 2006-133295

(51) Int. Cl. G09G 3/28

(52) U.S. Cl. 345/60

(57) ABSTRACT

A plasma display panel including a plurality of discharge cells each having a display electrode pair made of a scan electrode and a sustain electrode formed in a row direction, and a data electrode formed in a column direction is driven in one field period including a plurality of subfields. The subfield has an initializing period of making initializing discharge occur in the discharge cell, a writing period of making writing discharge occur by selectively applying a write pulse voltage to the discharge cells, and a sustain period of making sustain discharges of the number according to luminance weight occur in a selected discharge cell in the writing period. A write pulse voltage is applied to a discharge cell to be tested in a predetermined subfield, and the write pulse voltage is not applied to the discharge cell to be tested at least in a next subfield after the predetermined subfield.

### BACKGROUND OF THE INVENTION

1. Field of the Invention

The present invention relates to a method of testing lighting of a plasma display panel used for a wall-hanging television or large monitor.

2. Background Art

In a representative AC-face-discharge-type panel as a plasma display panel (hereinbelow, simply called “panel”), a number of discharge cells are formed between a front plate and a rear plate which are disposed so as to face each other.

In the front plate, a plurality of display electrode pairs each made of a scan electrode and a sustain electrode are formed in parallel with each other on a front glass substrate, and a dielectric layer and a protection layer are formed so as to cover the display electrode pairs. In the rear plate, a plurality of data electrodes parallel with each other are formed on a rear glass substrate, a dielectric layer is formed so as to cover the data electrodes, and a plurality of partition walls are formed on the dielectric layer in parallel with the data electrodes. A phosphor layer is formed on each of a surface of the dielectric layer and side faces of the partition walls.

The front plate and the rear plate are disposed so as to face each other so that the display electrode pairs and the data electrodes spatially cross each other, and are sealed. In an internal discharge space, for example, a discharge gas containing xenon of about 5% in partial pressure ratio is filled. The discharge cells are formed in the parts where the display electrode pairs and the data electrodes face each other. In the panel having such a configuration, ultraviolet light is generated by gas discharge in each of the discharge cells. With the ultraviolet light, phosphors of red (R), green (G), and blue (B) are excited to emit light, thereby displaying a color image.

As a method of driving the panel, the subfield method is generally used, which is a method of dividing one field period into a plurality of subfields and displaying a gray-scale image in accordance with a combination of subfields allowed to emit light.

Each subfield has an initialization period, a write period, and a sustain period. In the initialization period, initialization discharge occurs to form a wall charge necessary for the following writing operation on each of the electrodes. As an initializing operation, there are an initializing operation of making the initialization discharge occur in all of the discharge cells (hereinbelow, called “all-cell initializing operation”) and an initializing operation of making the initialization discharge occur in a discharge cell subjected to sustain discharge (hereinbelow, called “selective initializing operation”).

In the write period, a write pulse voltage is selectively applied to the discharge cells to display an image, thereby causing write discharge and forming wall charges (hereinbelow, this operation may be also written as “writing operation”). In the sustain period, a sustain pulse is applied alternately to the display electrode pairs made of the scan electrode and the sustain electrode, thereby causing sustain discharge in the discharge cells in which the write discharge has been occurred. The phosphor layers of the corresponding discharge cells are allowed to emit light, thereby turning on the discharge cells and displaying an image.

In the subfield method, for example, in the initializing period of one of a plurality of subfields, the all-cell initializing operation of discharging all of the discharge cells is performed. In the initializing period of each of the other subfields, the initializing discharge is selectively performed on the discharge cells subjected to the sustain discharge. In such a manner, light emission which is not related to the gray-scale image display is suppressed as much as possible, and the contrast ratio can be improved.

As described above, an image display screen of the panel is composed of a number of discharge cells arranged in a matrix, and light-on or light-off of each of the discharge cells is controlled according to the presence or absence of writing operation, thereby displaying an image. It is therefore important that a discharge cell in which the writing operation is performed emits light and a discharge cell in which the writing operation is not performed does not emit light. If the light emitting operation is not accurately performed, the quality of image display deteriorates.

A testing method for detecting a panel having a discharge cell which does not emit light although it is subjected to the writing operation is disclosed in Japanese Patent Unexamined Publication No. 2005-183367.

A main cause of occurrence of a discharge cell which does not emit light although it is subjected to the writing operation is considered as follows. A swell or a chip occurs in the partition wall for dividing adjacent discharge cells from each other. Charged particles enter from the adjacent discharge cell via the opening, and the wall charges are decreased. To find such a discharge cell, the above-described technique is effective.

On the other hand, another cause of the quality degradation in image display is the existence of a discharge cell which emits light although it is not subjected to the writing operation. By the above-described technique, however, such a discharge cell cannot be found.

### SUMMARY OF THE INVENTION

The present invention provides a panel lighting testing method for detecting a panel having a discharge cell which emits light although it is not subjected to a writing operation.

A panel lighting testing method of the present invention is a method of testing lighting of a panel including a plurality of discharge cells each having a display electrode pair made of a scan electrode and a sustain electrode formed in a row direction, and a data electrode formed in a column direction, for driving the panel in one field period including a plurality of subfields each having an initializing period of making initializing discharge occur in the discharge cell, a writing period of making writing discharge occur by selectively applying a write pulse voltage to the discharge cells, and a sustain period of making sustain discharges of the number according to luminance weight occur in a selected discharge cell in the writing period, and the method for performing gray-scale display by combining the subfields of turning on the discharge cells. In the method, the write pulse voltage is applied to a discharge cell to be tested in a predetermined subfield, and no write pulse voltage is applied to the discharge cell to be tested in at least a next subfield after the predetermined subfield. By the method, the panel having a discharge cell which emits light although it is not subjected to the writing operation can be detected.

In a method of testing lighting of a panel according to the present invention, the write pulse voltage is applied to a discharge cell to be tested in a predetermined subfield, and the write pulse voltage is not applied to the discharge cell to be tested at least in a range from a next subfield after the predetermined subfield to a final subfield in the field. According to the method, a discharge cell which emits light although it is not subjected to the writing operation can be found more easily.

In a method of testing lighting of a panel according to the present invention, the write pulse voltage is not applied to at least one of discharge cells adjacent to a discharge cell to be tested in a predetermined subfield and at least a next subfield after the predetermined subfield. According to the method, a discharge cell which emits light although it is not subjected to the writing operation since a discharge start voltage is decreased due to a chip or the like in the dielectric layer can be found more easily.

In a method of testing lighting of a panel according to the present invention, the write pulse voltage is applied to at least one of the discharge cells adjacent to the discharge cell to be tested in a predetermined subfield and at least a next subfield after the predetermined subfield. The method can find a discharge cell which emits light although it is not subjected to the writing operation due to leakage of ultraviolet light from a adjacent discharge cell by a chip or the like in a partition wall dividing the adjacent discharge cells.

In a method of testing lighting of a panel according to the present invention, the write pulse voltage is applied to at least one of discharge cells adjacent to the discharge cell to be tested in at least one of three subfields subsequent to the predetermined subfield. The method can detect the presence or absence of a discharge cell which emits light although it is not subjected to the writing operation due to leakage of ultraviolet light from a adjacent discharge cell by a chip or the like in a partition wall dividing the adjacent discharge cells in a period in which charged particles (priming particles) generated by the initial discharge remain.

In a method of testing lighting of a panel according to the present invention, at least one subfield in which the write pulse voltage is applied to the discharge cell to be tested and all of discharge cells adjacent to the discharge cell to be tested is provided in a range from a first subfield in a field to a last subfield before the predetermined subfield. In the method, charged particles useful to detect the presence or absence of a discharge cell which emit light although it is not subjected to the writing operation due to leakage of ultraviolet light from an adjacent discharge cell can be generated more certainly.

According to the present invention, a panel lighting testing method for detecting a panel having a discharge cell which emits light although it is not subjected to the writing operation can be provided.

### BRIEF DESCRIPTION OF THE DRAWINGS

FIG. 1 is an exploded perspective view showing the structure of a panel in a first embodiment of the present invention;

FIG. 2 is a diagram showing an electrode array of a panel in the first embodiment of the present invention;

FIG. 3 is a schematic diagram showing an array of discharge cells in an image display screen of the panel in the first embodiment of the present invention;

FIG. 4 is a waveform chart of a drive voltage applied to each of electrodes of the panel in the first embodiment of the present invention;

FIG. 5 is a diagram showing an example of a subfield configuration in the first embodiment of the present invention;

FIG. 6 is a circuit block diagram of a lighting testing apparatus in the first embodiment of the present invention;

FIG. 7A is a diagram showing an example of a write pattern in the first embodiment of the present invention;

FIG. 7B is a diagram showing an example of the write pattern in the first embodiment of the present invention;

FIG. 8A is a diagram showing an example of the write pattern in the first embodiment of the present invention;

FIG. 8B is a diagram showing an example of the write pattern in the first embodiment of the present invention;

FIG. 9A is a diagram showing an example of the write pattern in the first embodiment of the present invention;

FIG. 9B is a diagram showing an example of the write pattern in the first embodiment of the present invention;

FIG. 10A is a diagram showing an example of the write pattern in the first embodiment of the present invention;

FIG. 10B is a diagram showing an example of the write pattern in the first embodiment of the present invention;

FIG. 11A is a diagram showing an example of the write pattern in the first embodiment of the present invention;

FIG. 11B is a diagram showing an example of the write pattern in the first embodiment of the invention;

FIG. 12A is a diagram showing an example of the write pattern in the first embodiment of the present invention;

FIG. 12B is a diagram showing an example of the write pattern in the first embodiment of the present invention;

FIG. 13A is a diagram showing an example of a write pattern in a second embodiment of the present invention;

FIG. 13B is a diagram showing an example of the write pattern in the second embodiment of the present invention;

FIG. 14A is a diagram showing an example of the write pattern in the second embodiment of the present invention;

FIG. 14B is a diagram showing an example of the write pattern in the second embodiment of the present invention;

FIG. 15A is a diagram showing an example of the write pattern in the second embodiment of the present invention;

FIG. 15B is a diagram showing an example of the write pattern in the second embodiment of the present invention;

FIG. 16A is a diagram showing an example of the write pattern in the second embodiment of the present invention;

FIG. 16B is a diagram showing an example of the write pattern in the second embodiment of the present invention;

FIG. 17A is a diagram showing an example of the write pattern in the second embodiment of the present invention;

FIG. 17B is a diagram showing an example of the write pattern in the second embodiment of the present invention;

FIG. 18A is a diagram showing an example of the write pattern in the second embodiment of the present invention;

FIG. 18B is a diagram showing an example of the write pattern in the second embodiment of the present invention;

FIG. 19A is a diagram showing an example of the write pattern in the second embodiment of the present invention;

FIG. 19B is a diagram showing an example of the write pattern in the second embodiment of the present invention;

FIG. 20A is a diagram showing an example of the write pattern in the second embodiment of the present invention; and

FIG. 20B is a diagram showing an example of the write pattern in the second embodiment of the present invention.

### DETAILED DESCRIPTION OF THE PREFERRED EMBODIMENTS

### First Embodiment

A lighting testing apparatus used for carrying out a method of testing lighting of a panel in a first embodiment of the present invention will be described below with reference to the drawings.

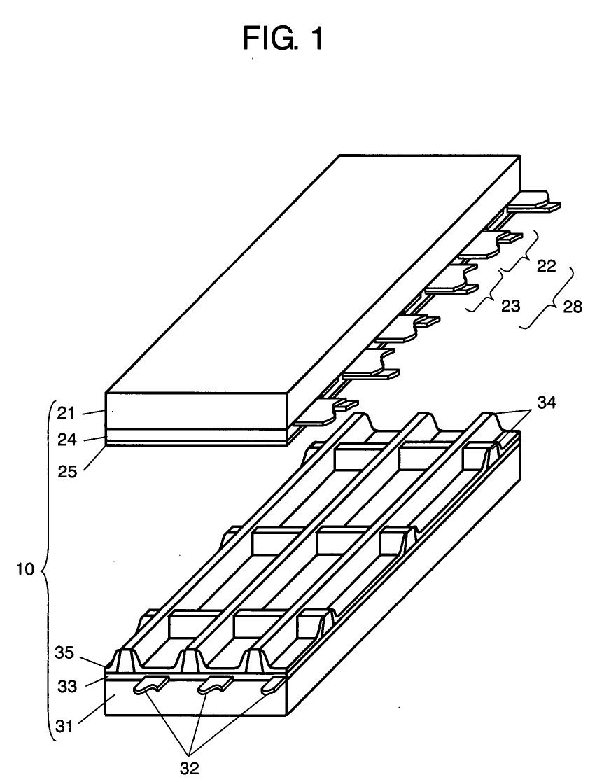

FIG. 1 is an exploded perspective view showing the structure of panel 10 in the first embodiment of the present invention. A plurality of display electrode pairs 28 each made of scan electrode 22 and sustain electrode 23 are formed on front plate 21 made of glass. Dielectric layer 24 is formed so as to cover scan electrode 22 and sustain electrode 23, and protection layer 25 is formed on dielectric layer 24. A plurality of data electrodes 32 are formed on rear plate 31, dielectric layer 33 is formed so as to cover data electrodes 32 and, further, partition lattice wall 34 is formed on dielectric layer 33. On side faces of partition wall 34 and on dielectric layer 33, phosphor layers 35 emitting light in red (R), green (G), and blue (B) are provided.

Front plate 21 and rear plate 31 are disposed facing each other so that display electrode pairs 28 and data electrodes 32 cross each other with a small discharge space therebetween, and the outer periphery is sealed by a sealing member such as glass frit. In the discharge space, for example, mixed gas of neon and xenon is filled as a discharge gas. The discharge space is partitioned into a plurality of sections by partition walls 34, and discharge cells are formed at intersections of display electrode pairs 28 and data electrodes 32. By discharge and light emission of the discharge cells, an image is displayed.

The structure of the panel is not limited to the above-described one but, for example, a structure having stripe partition walls may be also employed.

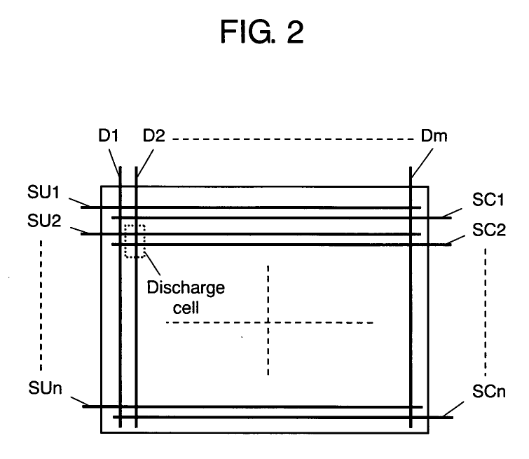

FIG. 2 is a diagram showing an electrode array of panel 10 in the first embodiment of the present invention. In panel 10, “n” pieces of scan electrodes SC1 to SCn (scan electrodes 22 in FIG. 1) and “n” pieces of sustain electrodes SU1 to SUn (sustain electrodes 23 in FIG. 1) which are long in the row direction are arranged, and “mn” pieces of data electrodes D1 to Dm (data electrodes 32 in FIG. 1) which are long in the column direction are arranged. A discharge cell is formed at an intersection of a pair of scan electrode SCi (i=1 to n) and sustain electrode SUi and one data electrode Dj (j=1 to m), and n×m pieces of discharge cells are formed in the discharge space.

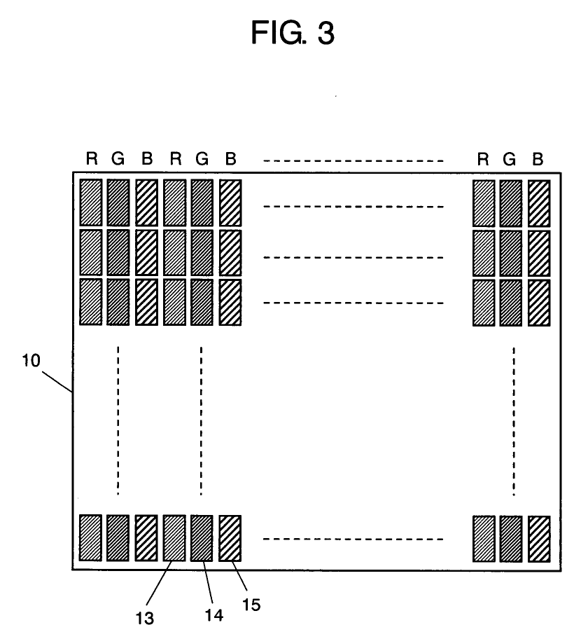

FIG. 3 is a schematic diagram showing an array of discharge cells in an image display screen of panel 10 in the first embodiment of the present invention. As shown in the diagram, in the image display screen of panel 10, discharge cells 13 provided with red phosphor layer 35 (hereinbelow, simply written as “R cells”), discharge cells 14 provided with green phosphor layer 35 (hereinbelow, simply written as “G cells”), and discharge cells 15 provided with blue phosphor layer 35 (hereinbelow, simply written as “B cells”) are arranged in a matrix of n rows and m columns. Discharge cells of the same color are arranged in the column direction, and discharge cells of different colors are arranged in order like R cell 13, G cell 14, and B cell 15 in the row direction.

Next, the waveform of the drive voltage for driving panel 10 and the operation of panel 10 will be described. A plasma display apparatus performs gray-level display by the subfield method, that is, by dividing one field period into a plurality of subfields and controlling light emission of each of the discharge cells on the subfield unit basis. Each of the subfields has an initialization period, a write period, and a sustaining period.

In the initialization period, initialization discharge occurs, and a wall charge necessary for the following write discharge is formed on each electrode. The initializing operation includes an initializing operation of making the initialization discharge occur in all of discharge cells (hereinbelow, referred to as “all-cell initializing operation”) and an initializing operation of making the initialization discharge occur in a discharge cell in which sustaining discharge is performed (hereinbelow, referred to as “selective initializing operation”).

In the write period, write discharge selectively occurs in a discharge cell to emit light, thereby forming a wall charge. In the sustain period, sustain pulses of the number proportional to the luminance weight are alternately applied to display electrode pair 28, sustain discharge occurs in the discharge cell in which the write discharge occurs, thereby emitting light. The proportionality factor at this time is called luminance factor.

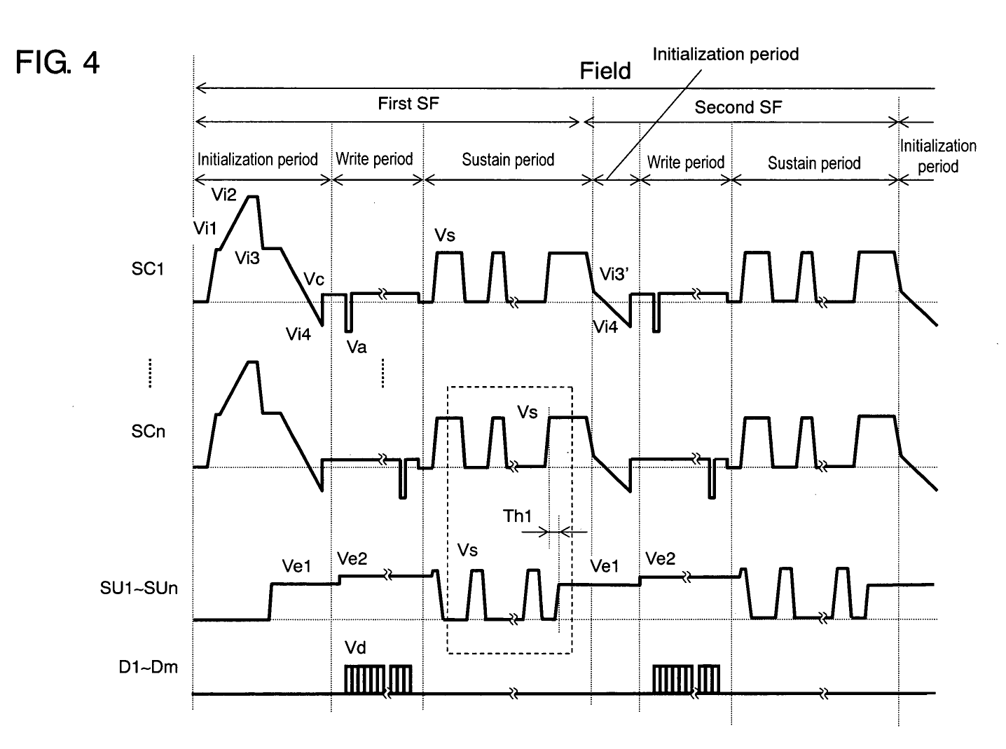

FIG. 4 is a waveform chart of a drive voltage applied to each of electrodes of panel 10 in the first embodiment of the present invention. FIG. 4 shows a subfield in which the all-cell initializing operation is performed and a subfield in which the selective initializing operation is performed.

First, the subfield in which the all-cell initializing operation is performed will be described.

In the first half of the initializing period, 0V is applied to each of data electrodes D1 to Dm and sustain electrodes SU1 to SUn. To scan electrodes SC1 to SCn, an inclined waveform voltage which gently rises from a voltage Vi1 equal to or below a discharge start voltage to a voltage Vi2 exceeding the discharge start voltage is applied to sustain electrodes SU1 to SUn.

During the rise of the inclined waveform voltage, weak initialization discharge occurs between scan electrodes SC1 to SCn and sustain electrodes SU1 to SUn and data electrodes D1 to Dm. A negative wall voltage is accumulated over scan electrodes SC1 to SCn and a positive wall voltage is accumulated over data electrodes D1 to Dm and sustain electrodes SU1 to SUn. The wall voltage on the electrodes expresses a voltage generated by the wall charge accumulated over the dielectric layer, the protection layer, the phosphor layer, and the like covering the electrodes.

In the latter half of the initialization period, positive voltage Ve1 is applied to sustain electrodes SU1 to SUn. In contrast to sustain electrodes SU1 to SUn, an inclined waveform voltage which gently decreases from voltage Vi3 equal to or lower than the discharge start voltage to voltage Vi4 exceeding the discharge start voltage is applied to scan electrodes SC1 to SCn. During the application, weak initialization discharge occurs between scan electrodes SC1 to SCn and sustain electrodes SU1 to SUn and data electrodes D1 to Dm. The negative wall voltage over scan electrodes SC1 and SCn and the positive wall voltage over sustain electrodes SU1 to SUn are weakened, and the positive wall voltage over data electrodes D1 to Dm is adjusted to the value adapted to the writing operation. By the above, the all-cell initializing operation for initialization-discharging all of the discharge cells is finished.

In the following write period, voltage Ve2 is applied to sustain electrodes SU1 to SUn, and voltage Vc is applied to scan electrodes SC1 to SCn.

Next, negative scan pulse voltage Va is applied to scan electrode SC1 in the first row, and positive write pulse voltage Vd is applied to data electrodes Dk (k=1 to m) of discharge cells to emit light in the first row in data electrodes D1 to Dm. The voltage difference in the intersection on data electrode Dk and scan electrode SC1 is obtained by adding the difference between the wall voltage on data electrode Dk and the wall voltage on scan electrode SC1 to the difference (Vd-Va) of the external application voltages, and it exceeds the discharge start voltage. Write discharge occurs between data electrode Dk and scan electrode SC1 and between sustain electrode SU1 and scan electrode SC1. A positive wall voltage is accumulated on scan electrode SC1 and a negative wall voltage is accumulated on sustain electrode SU1. A negative wall voltage is accumulated also on data electrode Dk.

In such a manner, the writing operation is performed by causing write discharge in the discharge cells to emit light in the first row and accumulating the wall voltage on the electrodes. On the other hand, the voltage in the intersection between data electrodes D1 to Dm to which write pulse voltage Vd is not applied and scan electrode SC1 does not exceed the discharge start voltage, so that the write discharge does not occur. The writing operation is performed to the discharge cells in the n-th row and, after that, the writing period is finished.

In the following sustain period, first, positive sustain pulse voltage Vs is applied to scan electrodes SC1 to SCn, and 0V is applied to sustain electrodes SU1 to SUn. In the discharge cells in which write discharge occurs, the difference between the voltage on scan electrode SCi and the voltage on sustain electrode SUi becomes equal to a value obtained by adding the difference between the wall voltage on scan electrode SCi and the wall voltage on sustain electrode SUi to sustain pulse voltage Vs, and it exceeds the discharge start voltage.

Sustain discharge occurs between scan electrode SCi and sustain electrode SUi and, by ultraviolet light generated at this time, phosphor layer 35 emits light. A negative wall voltage is accumulated on scan electrode SCi, and a positive wall voltage is accumulated on sustain electrode SUi. Further, the positive wall voltage is accumulated also on data electrode Dk. In the write period, sustain discharge does not occur in discharge cells in which the write discharge does not occur, and the wall voltage at the end of the initializing period is maintained.

Subsequently, 0V is applied to scan electrodes SC1 to SCn, and sustain pulse voltage Vs is applied to sustain electrodes SU1 to SUn. In discharge cells in which the sustain discharge occurs, the voltage difference between the voltage on sustain electrode SUi and the voltage on scan electrode SCi exceeds the discharge start voltage. Consequently, sustain discharge occurs again between sustain electrode SUi and scan electrode SCi, the negative wall voltage is accumulated on sustain electrode SUi, and the positive wall voltage is accumulated on scan electrode SCi.

Similarly, sustain pulses of the number obtained by multiplying the luminance weight with the luminance factor are applied alternately to scan electrodes SC1 to SCn and sustain electrodes SU1 to SUn, and the potential difference is applied across the electrodes of the display electrode pair. In such a manner, the sustain discharge successively occurs in the discharge cells in which the write discharge occurs in the write period.

At the end of the sustain period, the voltage difference of a narrow-width pulses is applied across scan electrodes SC1 to SCn and sustain electrodes SU1 to SUn. While leaving the positive wall voltage on data electrode Dk, the wall voltage on scan electrode SCi and sustain electrode SUi is canceled. To be concrete, the voltage on sustain electrodes SU1 to SUn is once reset to 0V and, after that, sustain pulse voltage Vs is applied to scan voltages SC1 to SCn. Sustain discharge occurs between sustain electrode SUi and scan electrode SCi of the discharge cell in which the sustain discharge occurs. Before the discharge is converged, that is, while sufficient charged particles generated by the discharge remain in the discharge space, voltage Ve1 is applied to sustain electrodes SU1 to SUn. Consequently, the voltage difference between sustain electrode SUi and scan electrode SCi is decreased to about (Vs-Ve1). While leaving the positive wall charge on data electrode Dk, the wall voltage between scan electrodes SC1 to SCn and sustain electrodes SU1 to SUn is decreased to about the difference (Vs-Ve1) of the voltages applied to the electrodes. Hereinbelow, this discharge is called “erase discharge”.

As described above, after voltage Vs for causing a final sustain discharge and, that is, the erase discharge is applied to scan electrodes SC1 to SCn, voltage Ve1 for decreasing the potential difference between the electrodes of the display electrode pair is applied to sustain electrodes SU1 to SUn. After that, the sustaining operation in the sustain period is finished.

Next, the operation of the subfield for performing the selective initializing operation will be described.

In the selective initializing period, while applying voltage Ve1 to sustain electrodes SU1 to SUn and 0V to data electrodes D1 to Dm, a lamp voltage which gently decreases from voltage Vi3′ to voltage Vi4 is applied to scan electrodes SC1 to SCn.

In the discharge cell in which the sustain discharge occurs in the sustain period of the preceding subfield, weak initialization discharge occurs, and the wall voltage on scan electrode SCi and sustain electrode SUi is decreased. Since the sufficient positive wall voltage is accumulated on data electrode Dk by the immediately preceding sustain discharge, an excessive part of the wall voltage is discharged and the wall voltage is adjusted be adapted to the writing operation.

On the other hand, the discharge cell in which the sustain discharge did not occur in the preceding subfield is not discharged, and the wall charge at the end of the initialization period of the preceding subfield is kept as it is. As described above, the selective initializing operation is an operation of selectively performing the initializing discharge on a discharge cell in which the sustaining operation is performed in the sustain period of the immediate preceding subfield.

Since the operation of the subsequent write period is similar to that of the write period of the subfield of performing the all-cell initializing operation, the description will not be repeated. The operation in the subsequent sustain period is similar except for the number of sustain pulses.

Next, the configuration of the subfield will be described.

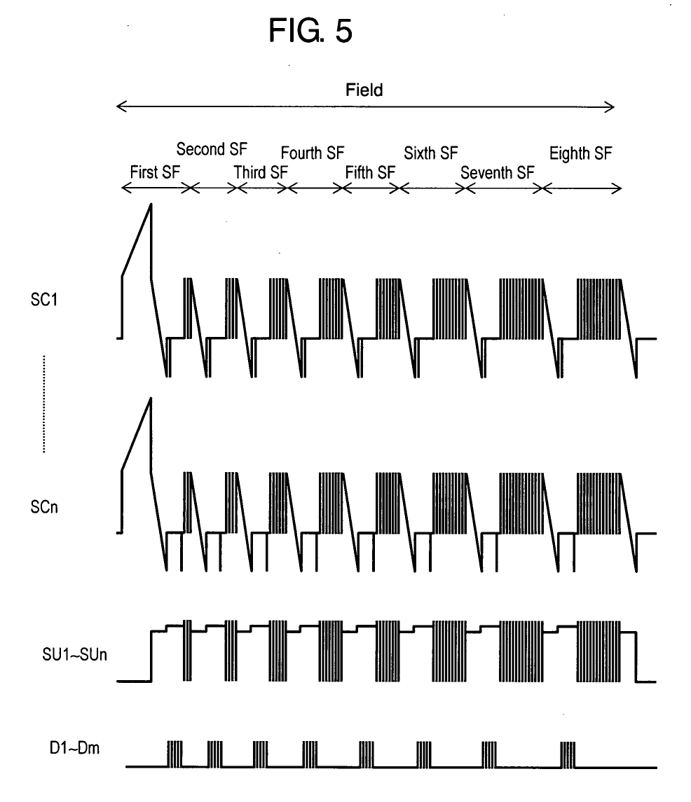

FIG. 5 is a diagram showing an example of the subfield configuration in the first embodiment of the present invention. FIG. 5 schematically shows drive voltage waveforms in one field in the subfield method. The drive voltage waveform of the subfield is equivalent to that of FIG. 4.

In the first embodiment, one field is divided in eight subfields (first SF, second SF, . . . , and eighth SF), and the subfields have luminance weights (1, 2, 4, 8, 16, 32, 64, and 128, respectively). In the sustain period of each of the subfields, the sustain pulses of the number according to the luminance weight of each of the subfields is applied to each of display electrode pairs 28. Therefore, 256 gray levels from 0 to 255 can be displayed according to a combination of subfields to be lighted. Each of the subfields is either a subfield on which the all-cell initializing operation is performed in the initializing period (hereinbelow, referred to as “all-cell initialization subfield”) or a subfield for performing the selective initializing operation in the initializing period (hereinbelow, called “selective initialization subfield”). In the first embodiment, the first SF is set as an all-cell initialization subfield and the second SF to the eighth SF are set as selective initialization subfields. In the initializing periods of the second SF to the eighth SF, the initializing discharge is selectively made only on a discharge cell in which the sustain discharge is made, so that light emission which is not related to the gray level display can be reduced as much as possible. Thus, the contrast ratio can be improved.

However, in the first embodiment, the number of subfields and the luminance weight of each of the subfields are not limited to the above-described values. The subfield configuration may be switched on the basis of the specifications of the panel or the like.

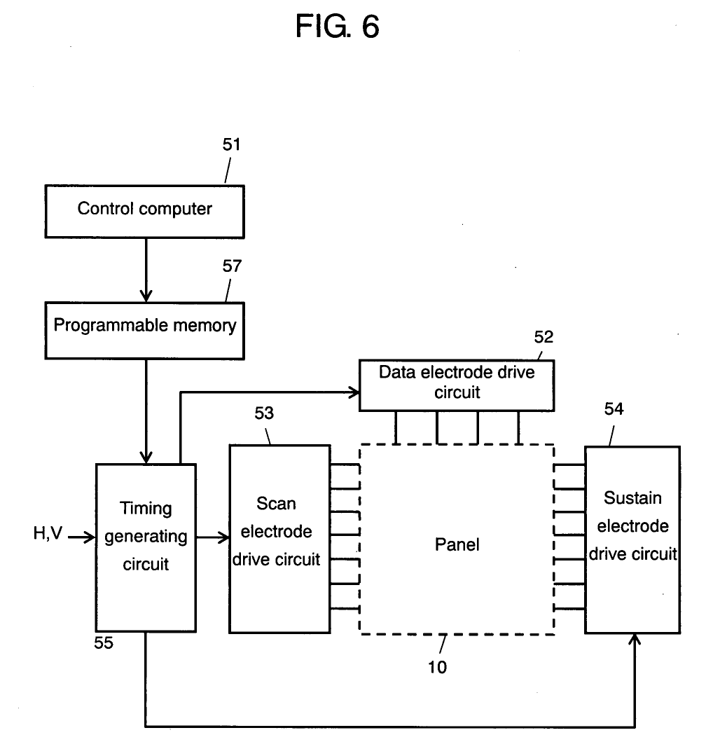

FIG. 6 is a circuit block diagram of a lighting testing apparatus in the first embodiment of the present invention. The lighting testing apparatus has data electrode drive circuit 52 for testing lighting of panel 10, scan electrode drive circuit 53, sustain electrode drive circuit 54, control computer 51, programmable memory 57, timing generating circuit 55, and a power supply circuit (not shown) for supplying power necessary for the circuit blocks. To data electrode drive circuit 52, scan electrode drive circuit 53, and sustain electrode drive circuit 54, panel 10 can be detachably connected. Tested panel 10 can be replaced with untested panel 10.

In the lighting testing apparatus in the first embodiment, control computer 51 generates a test pattern (hereinbelow, written as “write pattern”) which will be described later, and controls each of the drive circuits with the write pattern to conduct a lighting test on panel 10. The write pattern generated by control computer 51 is an application pattern of the write pulse voltage to be applied to data electrodes D1 to Dm in the write period. A signal indicative of the write pattern is transferred from control computer 51 to programmable memory 57 and stored in programmable memory 57 so as to be read from timing generating circuit 55.

Timing generating circuit 55 generates various timing signals for controlling operations of drive circuits on the basis of a horizontal sync signal H, a vertical sync signal V, and a test pattern read from programmable memory 57, and supplies the timing signals to the drive circuits.

On the basis of the timing signals from timing generating circuit 55, data electrode drive circuit 52 generates the above-described drive voltage waveforms for driving data electrodes D1 to Dm to drive data electrodes D1 to Dm. Scan electrode drive circuit 53 generates the drive voltage waveforms for driving scan electrodes SC1 to SCn to drive scan electrodes SCi to SCn. Sustain electrode drive circuit 54 generates the drive voltage waveform for driving sustain electrodes SU1 to SUn to drive sustain electrodes SU1 to SUn. In such a manner, the driving for testing lighting of panel 10 is performed.

In panel 10, there is a case such that a foreign matter enters dielectric layers 24 and 33, or dielectric layers 24 and 33 are partly thinned due to air bubbles generated in dielectric layers 24 and 33. Such a defect in the dielectric layer decreases the discharge start voltage of the discharge cell having the defect. There is the possibility that the voltage exceeds the discharge start voltage only by application of the sustain pulse voltage in a discharge cell to which data is not written, the sustain discharge occurs, and the discharge cell emits light.

Such a phenomenon tends to occur relatively easily in a next subfield after a subfield in which writing operation is performed and sustain discharge occurs. The reason seems that the discharge cell is in a state where discharge occurs relatively easily due to the selective initializing operation of selectively causing initializing discharge on the discharge cell subjected to the sustaining operation in the sustain period. Further, once sustain discharge occurs, the possibility that sustain discharge successively occurs in the subsequent subfield increases. Consequently, in the first embodiment, a panel lighting test for detecting a discharge cell having such a defect is conducted.

Next, the method of conducting the lighting test will be described.

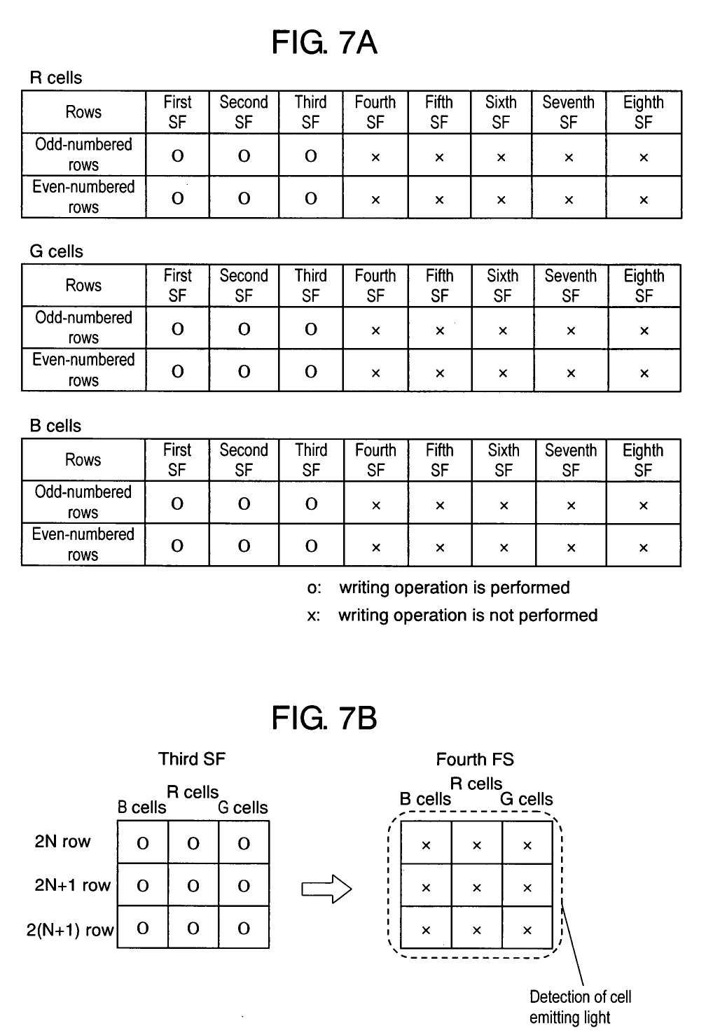

FIGS. 7A and 7B are diagrams showing an example of a write pattern in the first embodiment of the present invention. The write pattern is a pattern showing whether writing is performed by applying a write pulse voltage in the write period in each of the subfields or not. In the diagrams, “o” indicates that the writing operation is performed, and “x” expresses that the writing operation is not performed. The waveform of the drive voltage applied to each of the electrodes in panel 10 is similar to that of FIG. 4.

As shown in FIG. 7A, in the write pattern, the writing operation is performed successively from the first SF to the third SF in all of R, G, and B cells in the even-numbered rows (in the diagram, shown as 2N and 2(N+1), and N is a natural number) and the odd-numbered row (in the diagram, expressed as 2N+1), and the writing operation is not performed successively from the fourth SF to the eighth SF. Therefore, a normal discharge cell is switched, as shown in FIG. 7B, from the light-on state in third SF to the light-off state in the fourth SF. That is, by detecting a discharge cell which emits light in the fourth SF and subsequent SFs, an abnormal discharge cell can be detected.

In the first embodiment, by successively writing data from the first SF to the third SF, the discharge cell is easily discharged in the fourth SF. Further, the total of luminance weights from the first SF to the third SF is as low as 7/255 of the peak luminance, and the writing operation is not performed successively from the fourth SF to the eighth SF in which the luminance weights are heavier than the total of the luminance weights of the first SF to the third SF, thereby enabling a discharge cell emitting light brighter than the others to be easily detected as a discharge cell abnormally emitting light.

As described above, in the first embodiment, the write pulse voltage is applied to discharge cells to be detected in a predetermined subfield, and the write pulse voltage is not applied to the discharge cells to be target at least in the immediately subsequent subfield. Consequently, a discharge cell in which sustain discharge occurs and which emits light abnormally although it is not subjected to the writing operation can be detected.

In the first embodiment, the configuration in which the writing operation is performed successively from the first SF to the third SF and the writing operation is not performed successively from the fourth SF to the eighth SF has been described. However, the present invention is not limited to the configuration.

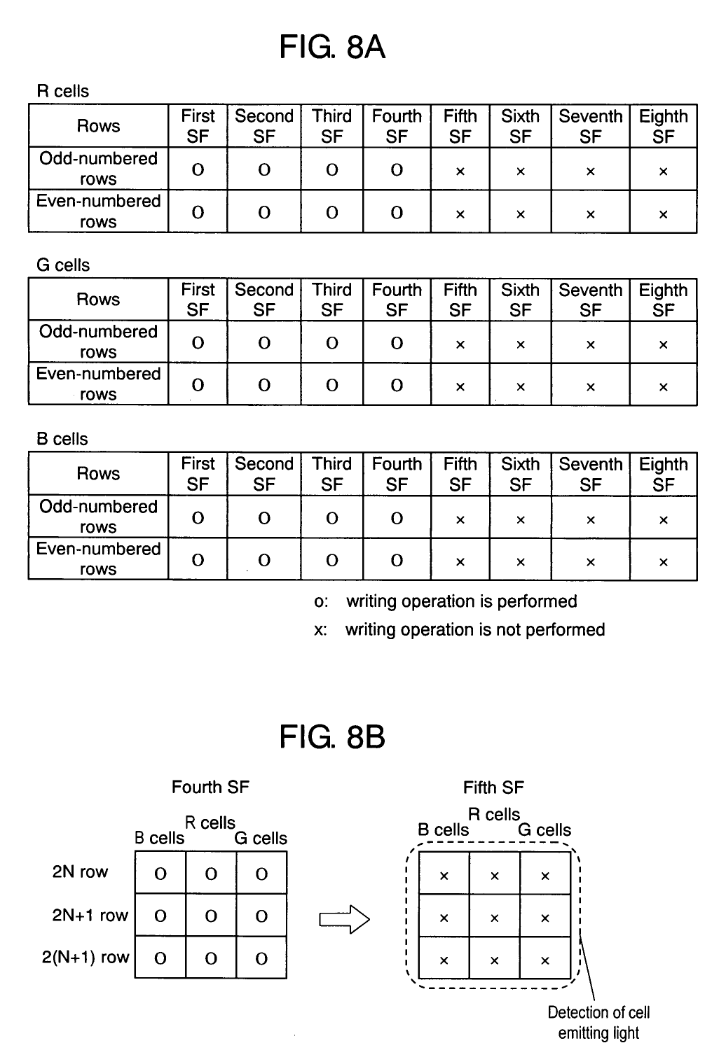

FIGS. 8A and 8B show another example of the write pattern in the first embodiment of the present invention. For example, as shown in FIG. 8A, the writing operation is performed successively from the first SF to the fourth SF, and the writing operation is not performed successively from the fifth SF to the eighth SF. In this case, the total of luminance weights from the first SF to the third SF is as low as 15/255 of the peak luminance and the writing is not performed successively from the fifth SF to the eighth SF in which the luminance weights are heavier than the total of the luminance weights of the first SF to the fourth SF, thereby enabling a discharge cell emitting light brighter than the others to be easily detected as a discharge cell abnormally emitting light.

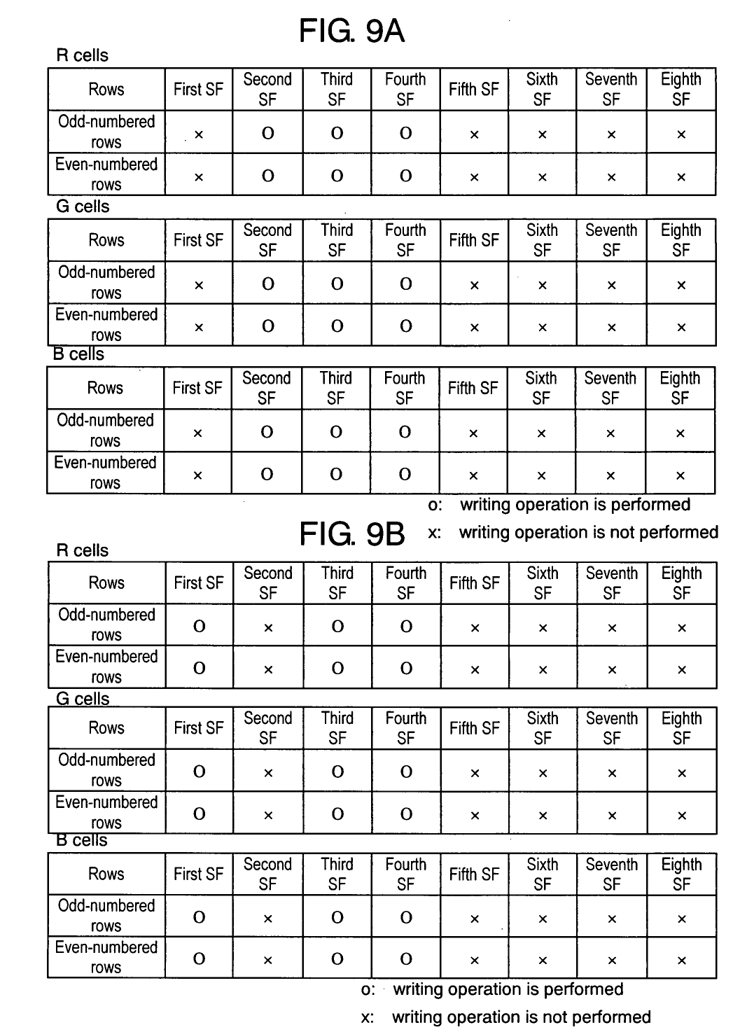

FIGS. 9A and 9B are diagrams showing further another example of the write pattern in the first embodiment of the present invention. For example, as shown in FIG. 9A, the writing operation is not performed in the first SF, the writing operation is performed successively from the second SF to the fourth SF, and the writing operation is not performed successively from the fifth SF to the eighth SF. As another example, as shown in FIG. 9B, the writing operation is not performed in the second SF, the writing operation is performed in the first SF, the third SF, and the fourth SF, and the writing operation is not performed successively from the fifth SF to the eighth SF. As described above, in a subfield of a small luminance weight such as the first SF and the second SF, without performing the writing operation in the subfield, effects similar to those of FIGS. 7A, 7B, 8A, and 8B can be obtained.

In the first embodiment, the configuration in which the writing operation is performed successively from the first SF to the third SF and writing is not performed successively from the fourth SF to the eighth SF in all of the R, G, and B cells in the even-numbered and odd-numbered rows has been described. The present invention, however, is not limited to the configuration but may be applied to a configuration of detecting a discharge cell which emits light abnormally in a specific row or column or as a specific discharge cell.

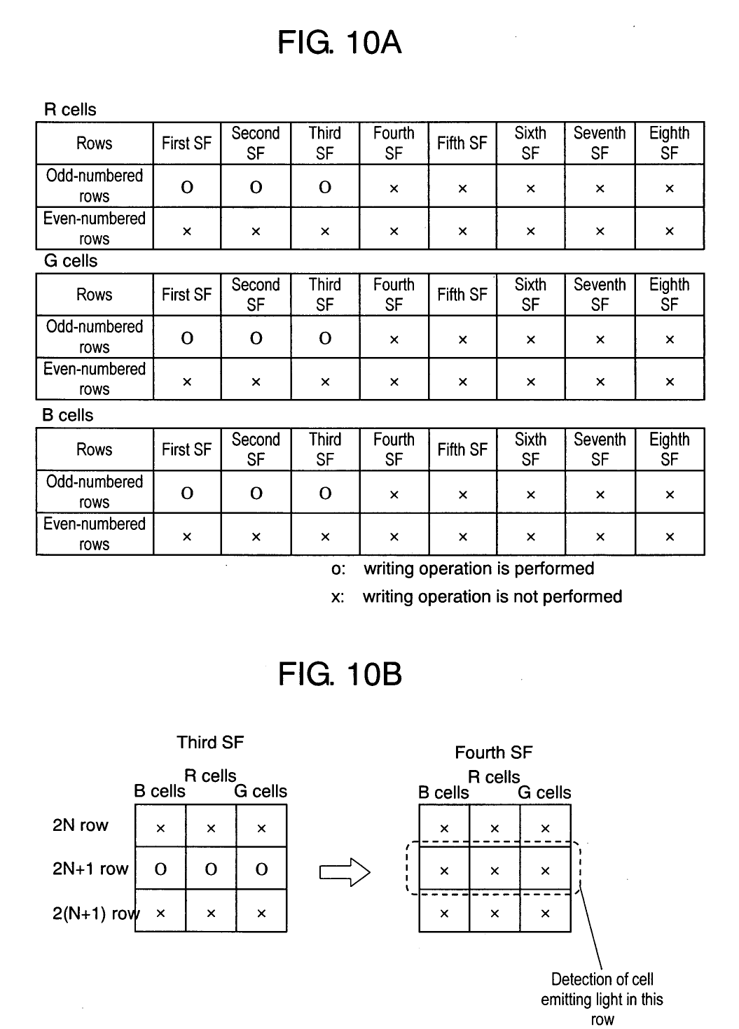

FIGS. 10A and 10B are diagrams showing further another example of the write pattern in the first embodiment of the present invention. For example, as shown in FIG. 10A, the writing operation is not performed in all of the subfields from the first SF to the eighth SF in all of R, G, and B cells in the even-numbered rows. The writing operation is performed successively from the first SF to the third SF, and the writing operation is not performed successively from the fourth SF to the eighth SF in all of the R, G, and B cells in the odd-numbered rows. In this case, as shown in FIG. 10B, in each of the discharge cells of the R cells, G cells, and B cells in the odd-numbered rows, a light-on state in the third SF is switched to a light-off state in the fourth SF. That is, by detecting a discharge cell emitting light in the fourth SF or subsequent SF, the lighting test of discharge cells in the odd-numbered rows can be performed. In this case, by interchanging the write pattern between the odd-numbered rows and the even-numbered rows, the lighting test can be conducted in the even-numbered rows.

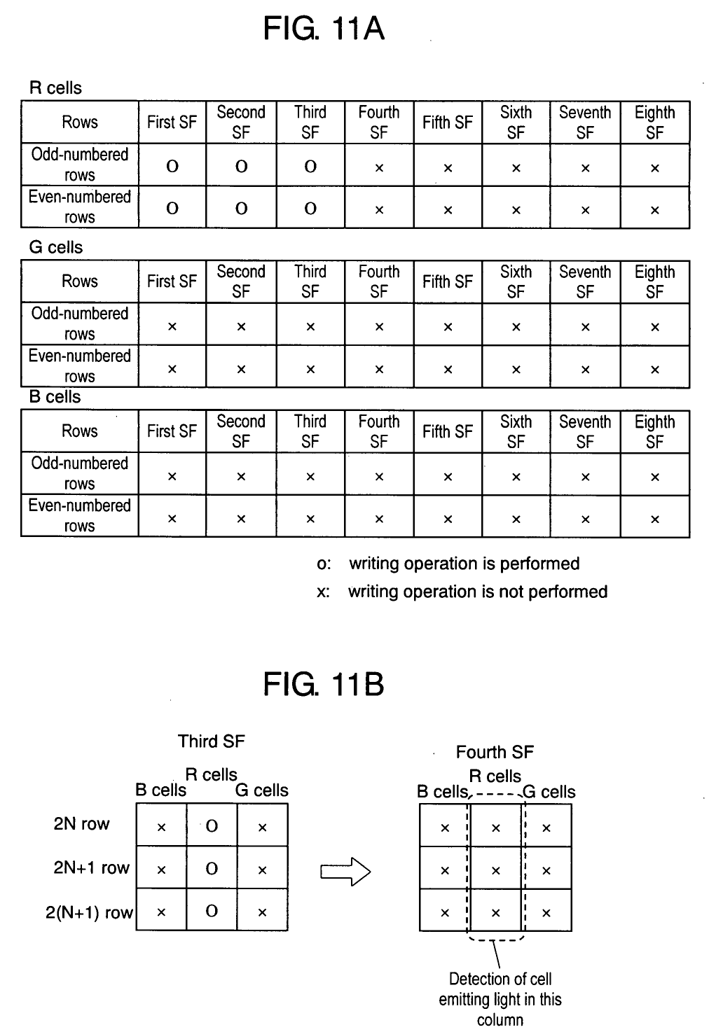

FIGS. 11A and 11B are diagrams showing further another example of the write pattern in the first embodiment of the present invention. For example, as shown in FIG. 11A, the writing operation is not performed in all of the subfields from the first SF to the eighth SF in all of G cells and B cells in the even-numbered and odd-numbered rows. In all of R cells in the even-numbered and odd-numbered rows, the writing operation is performed successively from the first SF to the third SF, and the writing operation is not performed successively from the fourth SF to the eighth SF. In this case, as shown in FIG. 11B, in each of the discharge cells of the R cells, a light-on state in the third SF is switched to a light-off state in the fourth SF. That is, by detecting a discharge cell which is on in the fourth SF and subsequent SFs, the lighting test of discharge cells in the R cells can be performed. In this case, by interchanging the write pattern between the R cells and the B cells or the G cells, the lighting test can be conducted in the B cells or the G cells.

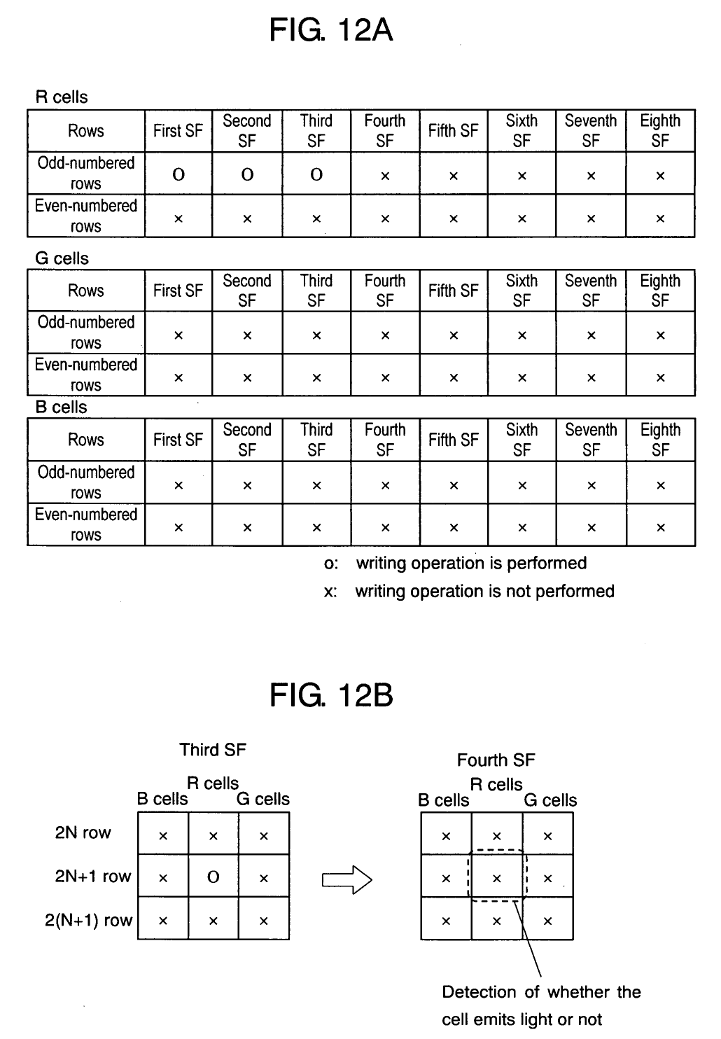

FIGS. 12A and 12B are diagrams showing further another example of the write pattern in the first embodiment of the present invention. For example, as shown in FIG. 12A, the writing operation is not performed in all of the subfields from the first SF to the eighth SF in all of G cells and B cells in the even-numbered and odd-numbered rows and all of R cells in the even-numbered rows, the writing operation is performed successively from the first SF to the third SF in all of R cells in the odd-numbered rows, and the writing operation is not performed successively from the fourth SF to the eighth SF. In this case, as shown in FIG. 12B, in the R cells in the odd-numbered row, a light-on state in the third SF is switched to a light-off state in the fourth SF. That is, by detecting a discharge cell emitting light in the fourth SF and subsequent SFs, the lighting test of discharge cells in the R cells in the odd-numbered rows can be performed. In this case, by interchanging the write pattern between the odd-numbered row and the even-numbered row or by interchanging the write pattern between the R cells and the B cells or the G cells, the lighting test can be conducted in the R cells in the even-numbered row or in the B cells or the G cells in the odd-numbered or even-numbered row.

### Second Embodiment

In the first embodiment, the configuration has been described such that a foreign matter enters dielectric layers 24 and 33, or dielectric layers 24 and 33 are partly thinned due to air bubbles generated in dielectric layers 24 and 33. It decreases the discharge start voltage of the discharge cell. Even though the writing operation is not performed, the sustain discharges occurs, and a discharge cell which emits light is detected. There are other causes of occurrence of the discharge cell emitting light although it is not subjected to the writing operation, such as a defect in partition wall 34.

For example, when a defect or the like occurs in partition wall 34 and the height of partition wall 34 is lower than the inherent height, there is a case such that ultraviolet light generated by the sustain discharge in a adjacent discharge cell cannot be interrupted, and a phosphor is excited by the leaked ultraviolet light, and emits light. It is difficult to detect abnormal light emission of a discharge cell generated by the defect or the like of partition wall 34 with the write patterns described in the first embodiment.

In the second embodiment, therefore, write patterns used for detecting a discharge cell which emits light abnormally due to a defect or the like in partition wall 34 will be described. Since the structure of panel 10, the waveform of a drive voltage applied to each of the electrodes, the configuration of the lighting testing apparatus, and the like of the second embodiment are similar to those of the first embodiment, the description will not be repeated.

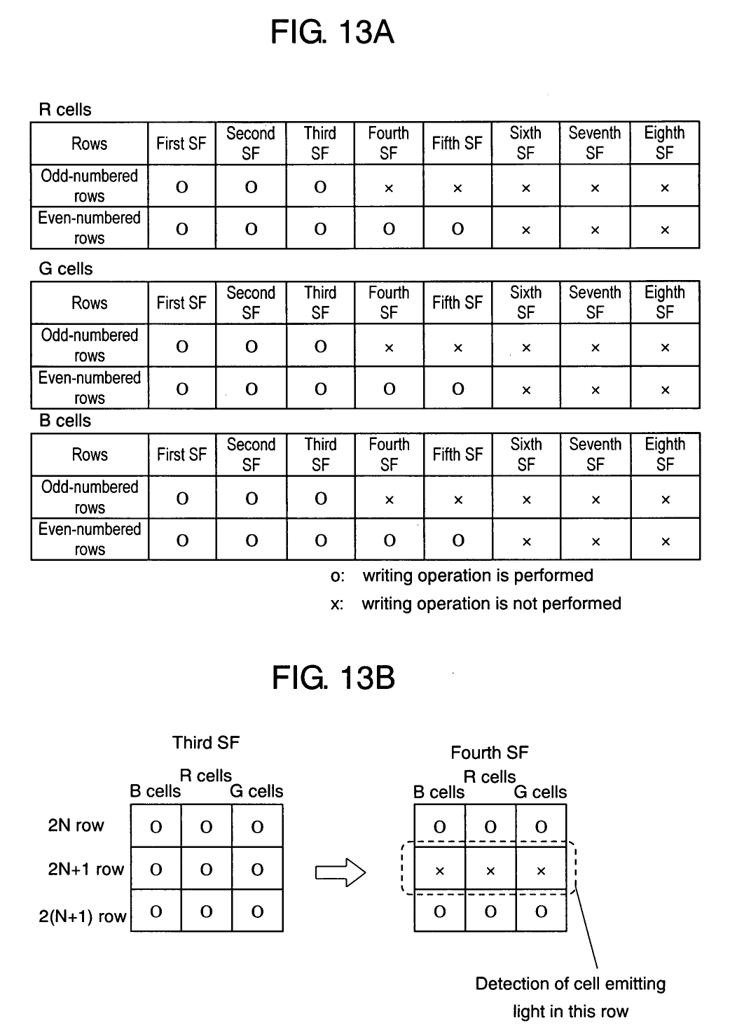

FIGS. 13A and 13B are diagrams showing an example of the write pattern in the second embodiment of the present invention. As shown in FIG. 13A, in the write pattern, the writing operation is performed successively from the first SF to the third SF, and the writing operation is not performed successively from the fourth SF to the eighth SF in all of R, G, and B cells in the odd-numbered rows. The writing operation is performed successively from the first SF to the fifth SF, and the writing operation is not performed successively from the sixth SF to the eighth SF in all of the R, G, and B cells in the even-numbered rows.

Therefore, when the discharge cells of the R, G, and B cells in the odd-numbered rows are separated from the discharge cells in the even-numbered rows by the normal partition walls, as shown in FIG. 13B, the discharge cells in the odd-numbered rows are switched from a light-on state in the third SF to a light-off state in the fourth SF. That is, by detecting a discharge cell emitting light in the fourth SF and subsequent SFs, a discharge cell which emits light abnormally can be detected.

In the second embodiment, the total of luminance weights from the first SF to the third SF as light-on subfields in the odd-numbered rows is as low as 7/255 of the peak luminance, and the writing operation is performed successively in the fourth SF and the fifth SF in which the luminance weights are heavier than the total of the luminance weights of the first SF to the third SF in the even-numbered rows, thereby enabling a discharge cell emitting light brighter than the others to be easily detected as a discharge cell abnormally emitting light. Further, sufficient charged particles are generated by making sustain discharge occur in all of the discharge cells in the first SF to the third SF, and sustain discharge is made occur in the discharge cells adjacent to a discharge cell to be tested in the fourth SF and the fifth SF in which a number of charged particles seem to remain, thereby enhancing the light emission intensity of abnormal lighting due to a defect or the like of partition wall 34 and further facilitating the detection.

As described above, in the second embodiment, the write pulse voltage is applied to a discharge cell to be tested in a predetermined subfield, and the write pulse voltage is not applied to a discharge cell to be tested in at least the immediately subsequent subfield. By continuing the sustain discharge by continuously applying the write pulse voltage to discharge cells adjacent to the discharge cell to be tested, a discharge cell in which a phosphor is excited by the ultraviolet light leaked from the adjacent discharge cell due to the defect or the like of partition wall 34, and which emits light abnormally although it is not subjected to the writing operation can be detected.

In the second embodiment, the configuration has been described in which the writing operation is performed successively in the first SF to the third SF in all of R, G, and B cells in the odd-numbered and even-numbered rows and, in all of the R, G, and B cells in the even-numbered rows, the writing operation is performed successively in the fourth and fifth SFs. However, the present invention is not limited to the configuration.

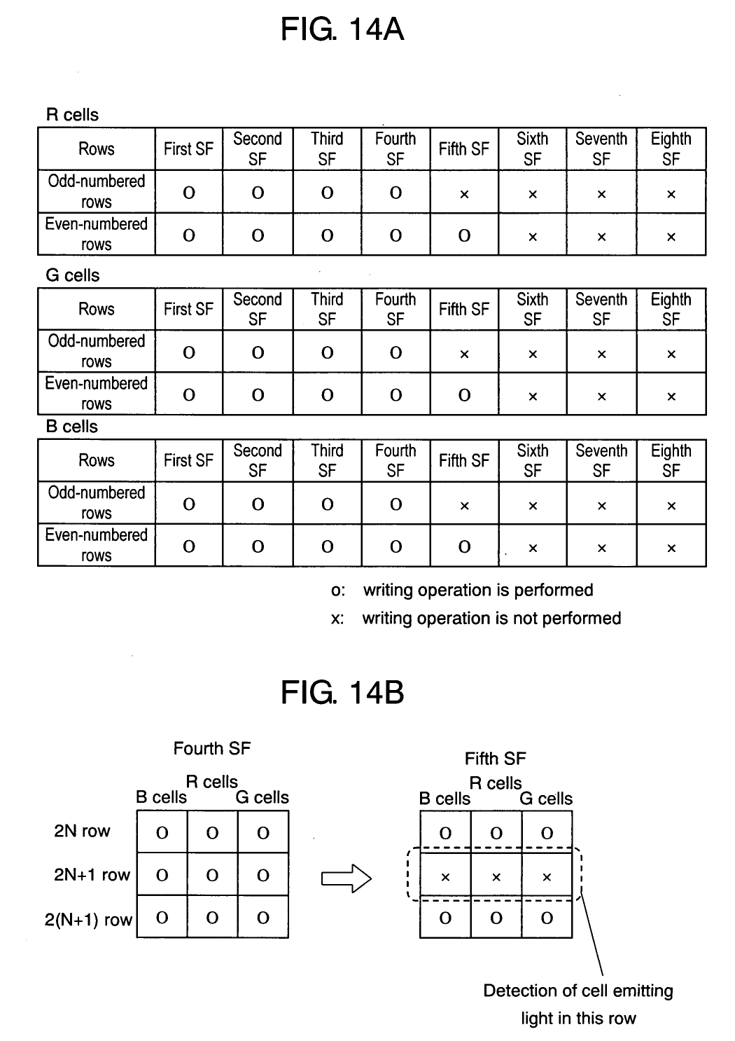

FIGS. 14A and 14B are diagrams showing another example of the write pattern in the second embodiment of the present invention. As shown in FIG. 14A, the writing operation is performed successively from the first SF to the fourth SF in all of R, G, and B cells in the odd-numbered and even-numbered rows. The writing operation is also performed in the fifth SF in all of the R, G, and B cells in the even-numbered rows, and no writing is performed in the other fields. In this case, the total of luminance weights from the first SF to the fourth SF is as low as 15/255 of the peak luminance, and the writing operation is performed in the fifth SF in which the luminance weight is heavier than the total of the luminance weights of the first SF to the fourth SF in the even-numbered rows. Consequently, by detecting discharge cells in the odd-numbered rows, which emit light in the fifth SF, a discharge cell abnormally emitting light can be detected. In the write patterns shown in FIGS. 13A, 13B, 14A, and 14B, by interchanging the write pattern between the even-numbered rows and the odd-numbered row, the lighting test can be conducted on the discharge cells in the even-numbered rows.

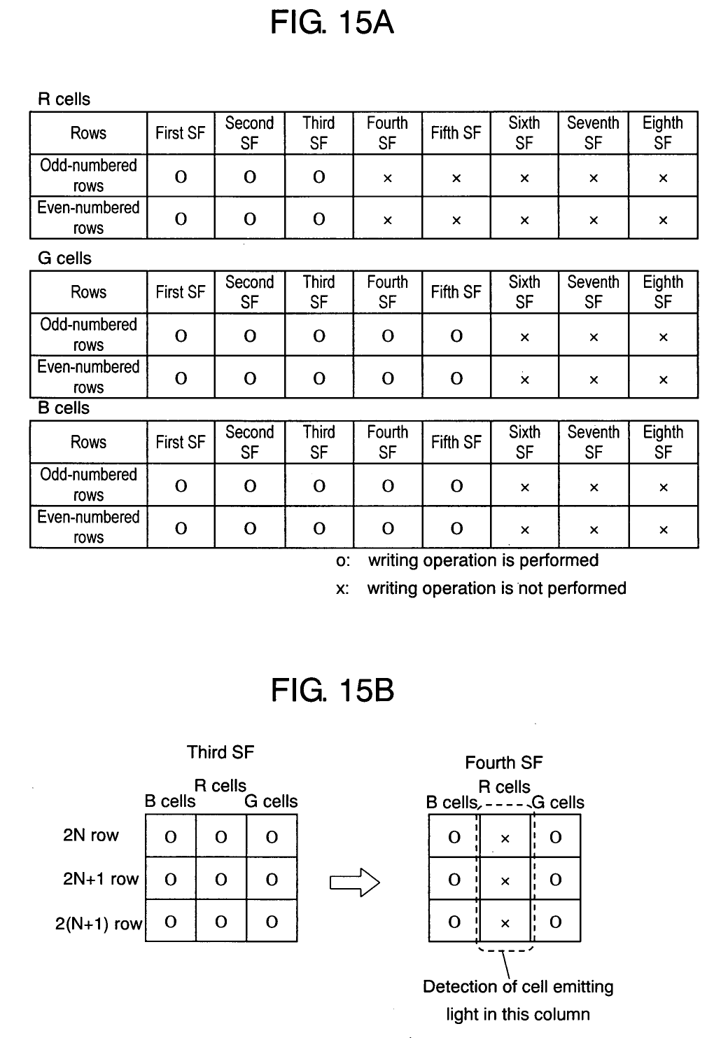

FIGS. 15A and 15B are diagrams showing further another example of the write pattern in the second embodiment of the present invention. As shown in FIG. 15A, the writing operation is performed successively from the first SF to the third SF in all of R, G, and B cells in the odd-numbered and even-numbered rows. The writing operation is also performed successively in the fourth SF and the fifth SF in all of the G cells and the B cells in the odd-numbered and even-numbered rows, and the writing operation is not performed in the other fields. In this case, as shown in FIG. 15B, the light-on state in the third SF is switched to the light-off state in the fourth SF in each of the discharge cells of the R cells. That is, by detecting the R cells which emit light in the fourth SF and the fifth SF, a discharge cell lighting test in the R cells can be conducted. In this case, by interchanging the write pattern between the R cell and the B cell or the G cell, the lighting test on the B cells or the G cell can be conducted.

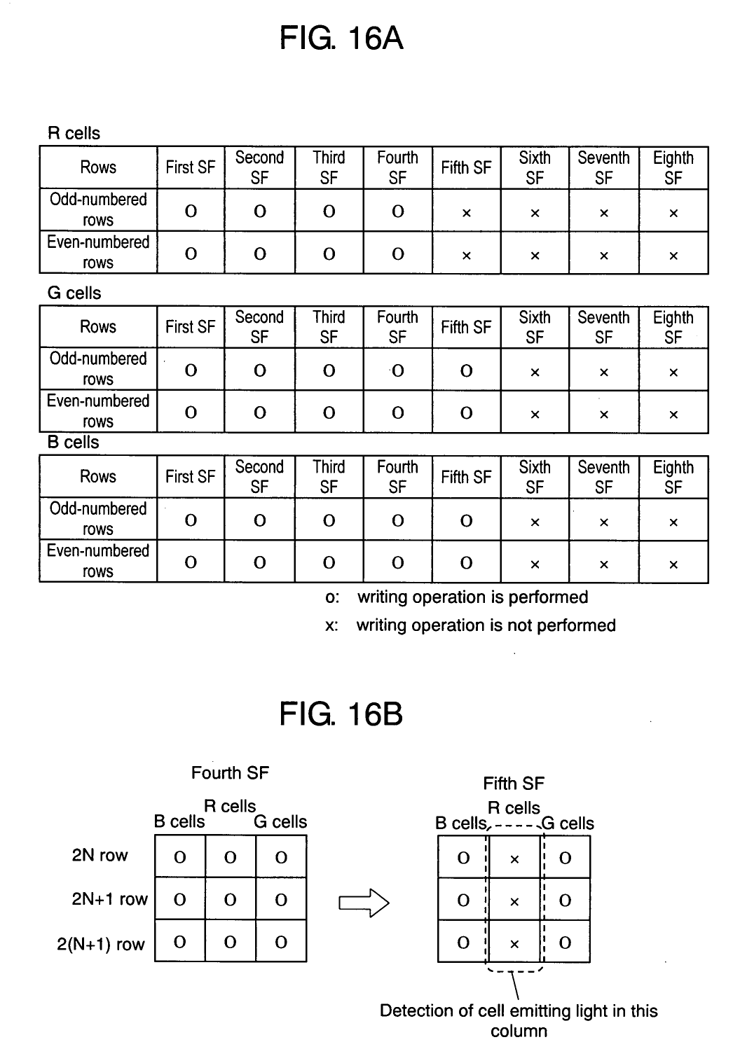

FIGS. 16A and 16B are diagrams showing further another example of the write pattern in the second embodiment of the present invention. For example, as shown in FIG. 16A, the writing operation is performed successively from the first SF to the fourth SF in all of R, G, and B cells in the odd-numbered and even-numbered rows. The writing operation is also performed in the fifth SF in all of the G and B cells in the odd-numbered and even-numbered rows, and no writing is performed in the other fields. In this case, as shown in FIG. 16B, the light-on state in the fourth SF is switched to the light-off state in the fifth SF in each of the discharge cells of the R cells. That is, by detecting the R cells which emit light in the fifth SF, a discharge cell lighting test in the R cells can be conducted. In this case, by interchanging the write pattern between the R cells and the B cells or the G cells, the lighting test on the B cells or the G cells can be conducted.

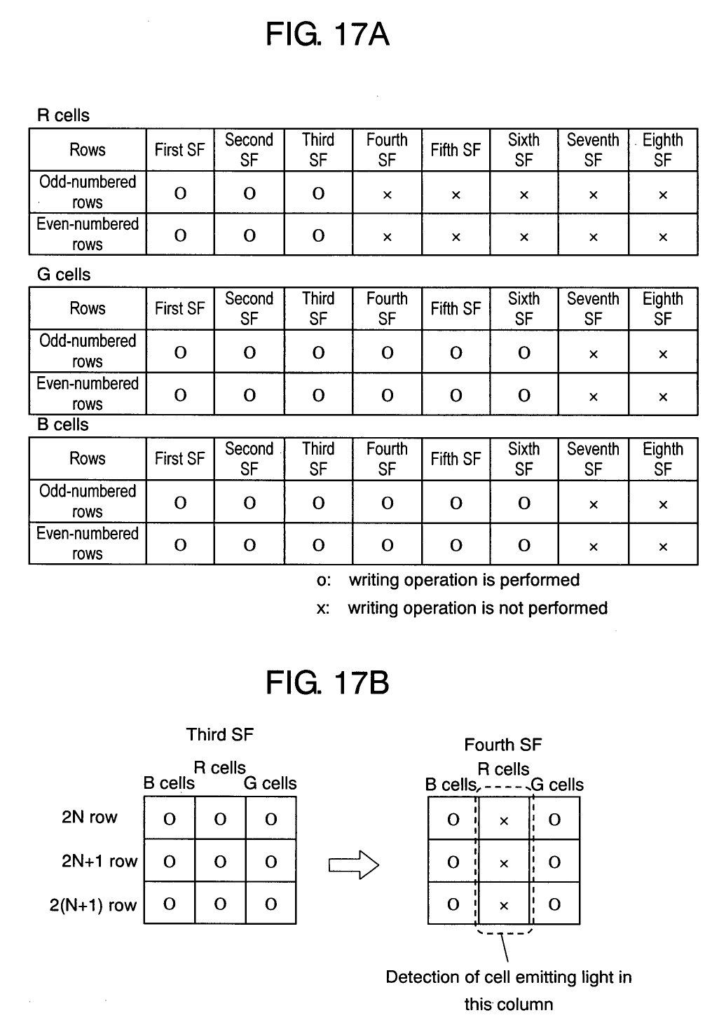

FIGS. 17A and 17B are diagrams showing further another example of the write pattern in the second embodiment of the present invention. For example, as shown in FIG. 17A, the writing operation is performed successively from the first SF to the third SF in all of R, G, and B cells in the odd-numbered and even-numbered rows. The writing operation is performed successively from the fourth SF to the sixth SF in the G cells and the B cells in the odd-numbered and even-numbered rows, and no writing is performed in the other fields. In this case, as shown in FIG. 17B, the light-on state in the third SF is switched to the light-off state in the fourth SF in each of the discharge cells of the R cells. That is, by detecting the R cells which emit light in the fourth SF to the sixth SF, a discharge cell lighting test in the R cells can be conducted. In this case, by interchanging the write pattern between the R cells and the B cells or the G cells, the lighting test on the B cells or the G cells can be conducted.

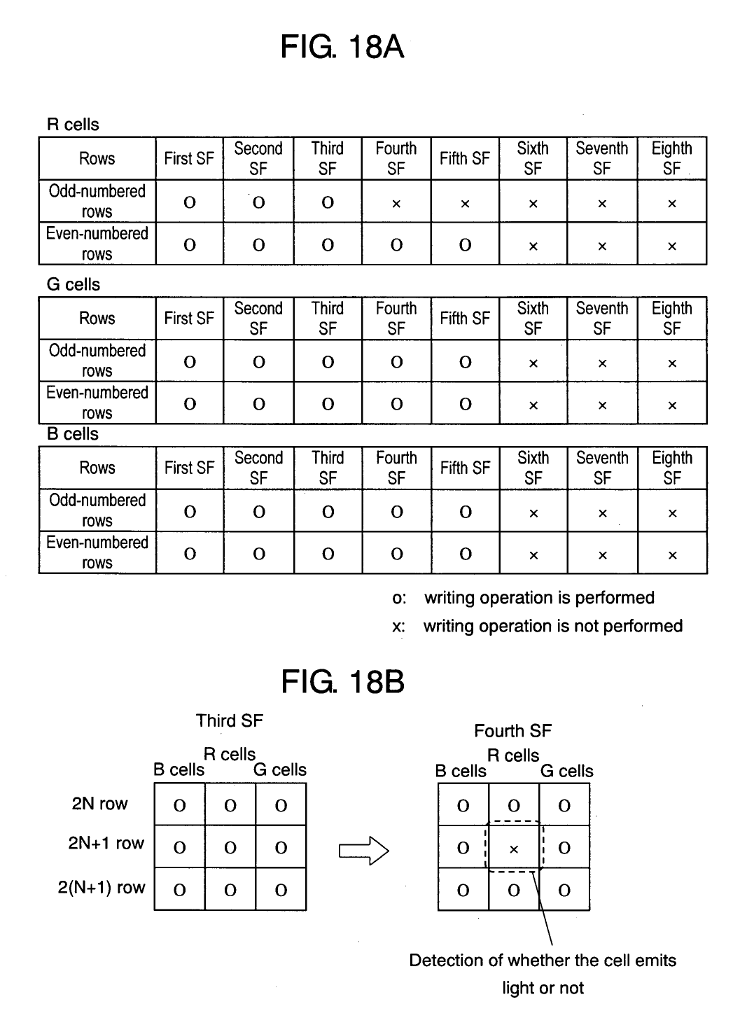

FIGS. 18A and 18B are diagrams showing further another example of the write pattern in the second embodiment of the present invention. For example, as shown in FIG. 18A, the writing operation is performed successively from the first SF to the third SF in all of R, G, and B cells in the odd-numbered and even-numbered rows. The writing operation is performed successively in the fourth SF and the fifth SF in the R cells in the even-numbered rows and in the G and B cells in the odd-numbered and even-numbered rows, and no writing is performed in the other fields. In this case, as shown in FIG. 18B, the light-on state in the third SF is switched to the light-off state in the fourth SF in R cells in the odd-numbered rows. That is, by detecting the R cells in the odd-numbered rows, which emit light in the fourth SF and the fifth SF, the lighting test in the R cells in the odd-numbered rows can be conducted. In this case, by interchanging the write pattern between the odd-numbered row and the even-numbered row or by interchanging the write pattern between the R cells and the B cells or the G cells, the lighting test can be conducted on the R cells in the even-numbered rows and the B cells or the G cells in the odd-numbered or even-numbered rows.

In the second embodiment, the configuration of successively performing the writing operation in all of the R, G, and B cells in the odd-numbered and even-numbered rows from the first subfield (the first SF) to a predetermined subfield (the third SF in FIGS. 13A, 13B, 15A, 15B, 17A, 17B, 18A, and 18B and the fourth SF in the FIGS. 14A, 14B, 16A, and 16B) in a field has been described. However, the present invention is not limited to the configuration. In the second embodiment, it is sufficient to provide at least one subfield in which the write pulse voltage is applied to the discharge cell to be tested and all of discharge cells adjacent to the discharge cell to be tested from the first subfield to the subfield just before a predetermined subfield in a field.

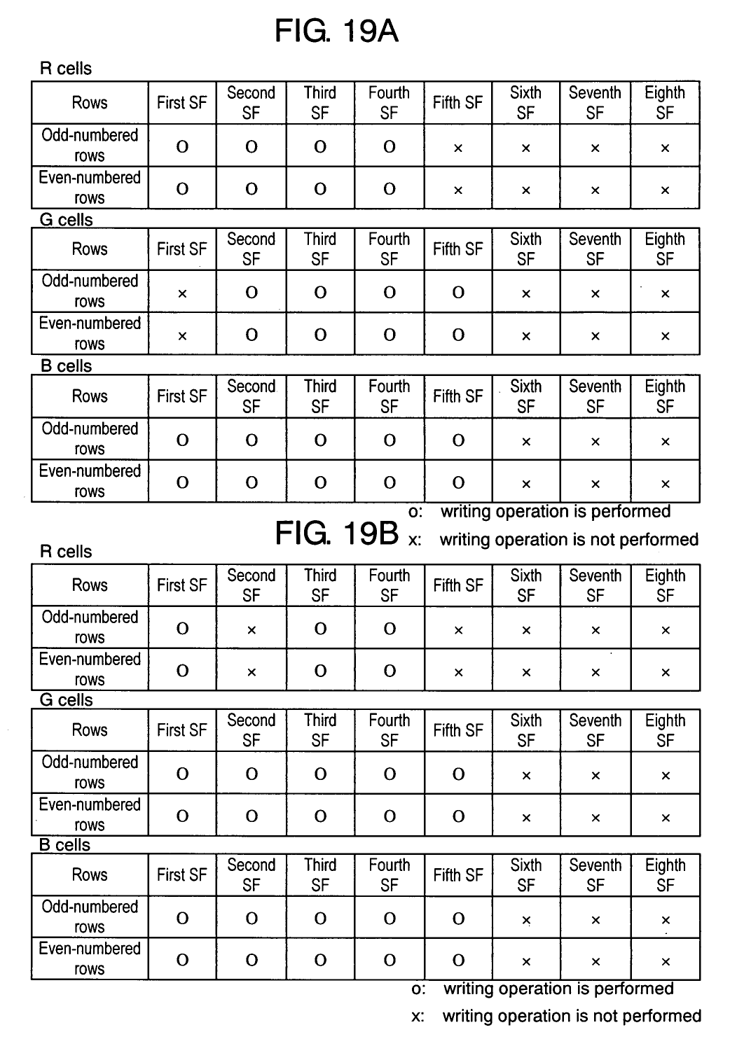

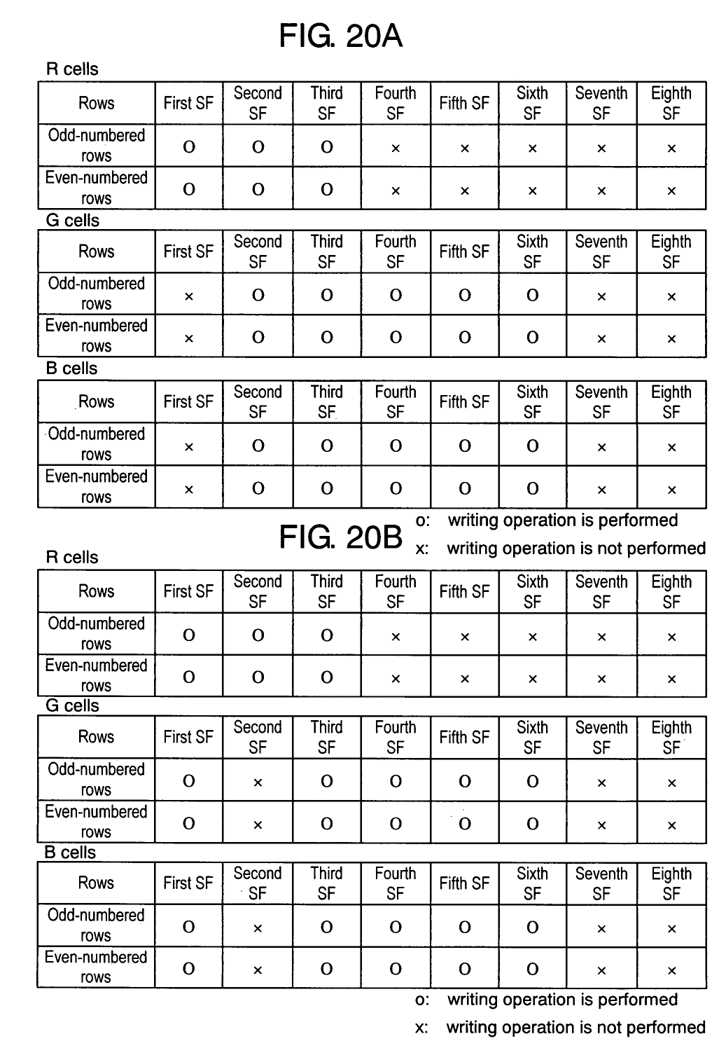

FIGS. 19A and 19B and FIGS. 20A and 20B are diagrams showing further another example of the write pattern in the second embodiment of the present invention. The write pattern shown in FIGS. 19A and 19B is similar to that shown in FIGS. 16A and 16B. The write pattern shown in FIGS. 20A and 20B is similar to that shown in FIGS. 17A and 17B. The write pattern shown in FIGS. 19A and 19B is different from that shown in FIGS. 16A and 16B with respect to the point that the writing operation is not performed in the R cells in the first SF in the write pattern shown in FIG. 19A and the writing operation is not performed in the R cells in the second SF in the write pattern shown in FIG. 19B. The write pattern shown in FIGS. 20A and 20B is different from that shown in FIGS. 17A and 17B with respect to the point that the writing operation is not performed in the G cells and the B cells in the first SF in the write pattern shown in FIG. 20A and the writing operation is not performed in the G cells and the B cells in the second SF in the write pattern shown in FIG. 20B.

As shown in the diagrams, in the second embodiment, it is not always necessary to write data successively in all of discharge cells from the first subfield to a predetermined subfield in a field. By providing at least one subfield in which the write pulse voltage is applied to a discharge cell to be tested and discharge cells adjacent to the discharge cell to be tested between the first subfield to a subfield just before the predetermined subfield in the field, charged particles necessary for the lighting test can be generated.

It is desirable to write data in the next subfield after a predetermined subfield in discharge cells adjacent to the discharge cell to be tested, but the present invention is not always limited to the configuration. By performing the writing operation in at least one subfield out of next three fields after the predetermined subfield, the lighting test in the second embodiment can be conducted.

In the lighting testing apparatus in the second embodiment of the present invention, a discharge cell which abnormally emits light can be visually detected by an inspector. In this case, it is desirable to provide a sufficient test period by forming a test pattern in such a manner that a plurality of fields are continued or the like so that a discharge cell emitting light abnormally and a normal discharge cell can be distinguished from each other.

Alternatively, an identification unit having a CCD camera or the like capable of automatically distinguishing a discharge cell emitting light abnormally and a normal discharge cell from each other is constructed and can be used in combination with the lighting testing apparatus in the second embodiment. In this configuration, distinguishing operation can be performed at high speed. Consequently, for example, one test pattern is formed per field. A test can be conducted while switching various test patterns, for example, interchange of the write pattern among the R, G, and B cells or interchange of the write pattern between the even-numbered row and the odd-numbered row. Thus, test time can be shortened.

Although the configuration of forming partition walls 34 in a lattice shape has been described in the second embodiment of the present invention, the lighting test can be conducted in a manner similar to the above also on a panel having no partition walls in the row direction.

Although the configuration of performing the panel lighting test by using the lighting testing apparatus has been described in the second embodiment of the present invention, by using the lighting testing method of the present invention, a similar lighting test can be conducted on also a plasma display apparatus having various drive circuits.

In the second embodiment of the present invention, the subfield configuration in which the first SF is set as the all-cell initializing subfield and the second SF to the tenth SF are set as the selective initializing subfields has been described as an example. However, the present invention is not limited to the subfield configuration. The other subfield configurations such as a configuration of setting all of subfields as the selective initializing subfields may be employed.

The concrete numerical values used in the second embodiment of the present invention are just an example. It is desirable to set optimum values in accordance with the characteristics of a panel, the specifications of a plasma display apparatus, or the like.

The panel lighting testing method of the present invention is useful for the reason that a panel having a discharge cell which emits light although it is not subjected to the writing operation can be detected.

What is claimed is:

1. A method of testing lighting of a plasma display panel including a plurality of discharge cells each having a display electrode pair made of a scan electrode and a sustain electrode formed in a row direction, and a data electrode formed in a column direction,
for driving the plasma display panel in one field period including a plurality of subfields each having
an initializing period of making initializing discharge occur in the discharge cell,
a writing period of making writing discharge occur by selectively applying a write pulse voltage to the discharge cells, and
a sustain period of making sustain discharges of the number according to luminance weight occur in a selected discharge cell in the writing period, and
the method for performing gray-scale display by combining the subfields of turning on the discharge cells, comprising:
a voltage applying step for applying the write pulse voltage to a discharge cell to be tested in a predetermined subfield; and
a no-voltage applying step for applying no write pulse voltage to the discharge cell to be tested in at least a next subfield after the predetermined subfield.

2. The method of testing lighting of a plasma display panel according to claim 1, wherein the no-voltage applying step is for applying no write pulse voltage to the discharge cell to be tested in a range from the next subfield after the predetermined subfield to a final subfield of the field.

3. The method of testing lighting of a plasma display panel according to claim 1, further comprising:
applying no write pulse voltage to at least one of discharge cells adjacent to the discharge cell to be tested in a predetermined subfield and at least a next subfield after the predetermined subfield.

4. The method of testing lighting of a plasma display panel according to claim 2, further comprising:
applying no write pulse voltage to at least one of the discharge cells adjacent to the discharge cell to be tested in a predetermined subfield and at least a next subfield after the predetermined subfield.

5. The method of testing lighting of a plasma display panel according to claim 1, further comprising:
applying the write pulse voltage to at least one of the discharge cells adjacent to the discharge cell to be tested in a predetermined subfield and at least a next subfield after the predetermined subfield.

6. The method of testing lighting of a plasma display panel according to claim 2, further comprising:
applying the write pulse voltage to at least one of the discharge cells adjacent to the discharge cell to be tested in a predetermined subfield and at least a next subfield after the predetermined subfield.

7. The method of testing lighting of a plasma display panel according to claim 1, further comprising:
applying the write pulse voltage to at least one of discharge cells adjacent to the discharge cell to be tested in at least one of three subfields subsequent to the predetermined subfield.

8. The method of testing lighting of a plasma display panel according to claim 2, further comprising:
applying the write pulse voltage to at least one of discharge cells adjacent to the discharge cell to be tested in at least one of three subfields subsequent to the predetermined subfield.

9. The method of testing lighting of a plasma display panel according to claim 5, wherein at least one subfield in which the write pulse voltage is applied to the discharge cell to be tested and all of discharge cells adjacent to the discharge cell to be tested is provided in a range from a first subfield in a field to a last subfield before the predetermined subfield.

10. The method of testing lighting of a plasma display panel according to claim 6, wherein at least one subfield in which the write pulse voltage is applied to the discharge cell to be tested and all of discharge cells adjacent to the discharge cell to be tested is provided in a range from a first subfield in a field to a last subfield before the predetermined subfield.

11. The method of testing lighting of a plasma display panel according to claim 7, wherein at least one subfield in which the write pulse voltage is applied to the discharge cell to be tested and all of discharge cells adjacent to the discharge cell to be tested is provided in a range from a first subfield in a field to a last subfield before the predetermined subfield.

12. The method of testing lighting of a plasma display panel according to claim 8, wherein at least one subfield in which the write pulse voltage is applied to the discharge cell to be tested and all of discharge cells adjacent to the discharge cell to be tested is provided in a range from a first subfield in a field to a last subfield before the predetermined subfield.
